(19) United States
(12) Patent Application Publication
(10) Pub. No.: US 2016/0212328 A1
(43) Pub. Date: Jul. 21, 2016

(54) HAPTIC INTERFACE OF IMAGE PHOTOGRAPHING DEVICE AND CONTROL METHOD THEREOF

(71) Applicant: SAMSUNG ELECTRONICS CO., LTD., Suwon-si (KR)

(72) Inventors: Jin-won LEE, Seongnam-si (KR); Yong-hee LEE, Seoul (KR)

(73) Assignee: SAMSUNG ELECTRONICS CO., LTD., Suwon-si (KR)

(21) Appl. No.: 14/980,133

(22) Filed: Dec. 28, 2015

(30) Foreign Application Priority Data
Jan. 15, 2015 (KR) 10-2015-0007322

(51) Int. Cl. H04N 5/232; G06F 3/01

(52) U.S. Cl. CPC H04N 5/23216; G06F 3/016

(57) ABSTRACT

An image photographing device and a control method thereof are provided. The image photographing device includes: a camera configured to photograph an image; an inputter configured to receive an input of a user command; a haptic unit disposed on an area of a body of the image photographing device at which a user grips the image photographing device and configured to provide a vibration feedback to the user; and a controller configured to control the haptic unit to provide a vibration feedback that corresponds to a user command in response to the user command being received via the inputter.

### CROSS-REFERENCE TO RELATED APPLICATIONS

This application claims priority from Korean Patent Application No. 10-2015-0007322, filed on Jan. 15, 2015, in the Korean Intellectual Property Office, the disclosure of which is incorporated herein by reference in its entirety.

### BACKGROUND

1. Field

Apparatuses and methods consistent with exemplary embodiments relate to an image photographing device and a control method thereof, and more particularly, to an image photographing device which can provide a vibration feedback that corresponds to a user command and to which a user command is inputted via a touch screen, and a control method thereof.

2. Description of the Related Art

With the development of electronic technologies, various kinds of image photographing devices have been developed and distributed. Most of the currently used image photographing devices (for example, a Digital Single Lens Reflex (DSLR) camera, a camcorder, etc.) show good performance in comparison to the other image photographing devices, but have the disadvantage of deteriorating portability due to their relatively large sizes. In addition, the existing image photographing device has difficulty in magnifying a display screen of a photographed image while maintaining arrangements of physical buttons or a jog dial.

Accordingly, there is a demand for various methods for miniaturizing the size of the image photographing device and magnifying the display screen. For example, a mirrorless camera or a compact system camera that does not include a mirror box in the DSLR camera has been developed and distributed. In addition, a camera that does not include either of a physical button or a jog dial has been developed and distributed.

However, the existing image photographing device that does not include the mirror box has enhanced portability, but reduces a photographing efficiency. For example, such an image photographing device is not able to use an extra phase difference sensor in view of its structure, and thus, there are problems that an auto focus speed is reduced and photographing sensitivity is reduced with the introduction of an electronic viewfinder for substituting for an optical viewfinder.

In addition, as the physical button or jog dial is removed from the existing photographing device for the purpose of magnifying a screen on which an image is displayed, the usability of the device is reduced.

Therefore, there is a demand for an image photographing device which can provide enhanced photographing sensitivity to a user while improving portability of the image photographing device.

### SUMMARY

Exemplary embodiments overcome the above disadvantages and other disadvantages not described above. Also, the exemplary embodiments are not required to overcome the disadvantages described above, and an exemplary embodiment may not overcome any of the problems described above.

One or more exemplary embodiments provide an image photographing device which provides a vibration feedback that corresponds to a user command and to which a user command is inputted via a touch screen or a grip region of the image photographing device, and a control method.

According to an aspect of one or more exemplary embodiments, an image photographing device includes: an image obtainer configured to photograph an image; an inputter configured to receive an input of a user command; a haptic component disposed on an area of a body of the image photographing device at which a user grips the image photographing device and configured to provide a first vibration feedback to the user; and a controller configured to control the haptic component to provide the first vibration feedback that corresponds to the user command in response to the user command being received via the inputter.

The inputter may include a shutter button configured to receive an input of at least one from among a photographing command and an auto focusing command, and, in response to the at least one from among the photographing command and the auto focusing command being received via the shutter button, the controller may be further configured to control the haptic component to provide the first vibration feedback based on the received at least one from among the photographing command and the auto focusing command.

The inputter may include a touch screen configured to receive a user touch input and to display an image photographed by the image obtainer, and, in response to the user command being received via the touch screen, the controller may be further configured to control the haptic component to provide the first vibration feedback based on the user command.

The inputter may further include a touch haptic component configured to provide a second vibration feedback on the touch screen, and, in response to the user command being received via the touch screen, the controller may be further configured to control the touch haptic component to provide the second vibration feedback to a first point on the touch screen at which the user command is inputted.

In response to a user touch input which is received at a second point on the touch screen, the controller may be further configured to control the touch screen to display a jog dial user interface (UI) at the second point, and to control the touch haptic component to provide a third vibration feedback to the second point.

The touch screen may further include a touch pressure sensor configured to detect a touch pressure of the user, and the controller may be further configured to control the touch haptic component to provide a third vibration feedback based on the detected touch pressure, such that the third vibration feedback is different from the first vibration feedback and the second vibration feedback.

The haptic component may include a plurality of actuators disposed on the area at which the user grips the image photographing device, and the controller may be further configured to drive each of the plurality of actuators at a different respective time in order to provide a different respective vibration feedback based on the user command.

The haptic component may include an actuator which includes a plunger, and the actuator may be configured to linearly reciprocate in a vertical direction or a horizontal direction.

The haptic component may include an actuator which has a form of a thin film.

According to another aspect of the one or more exemplary embodiments, a control method of an image photographing device includes: photographing an image; receiving an input of a user command via an inputter; and controlling a haptic component to provide a first vibration feedback that corresponds to the user command in response to the user command being received.

The inputter may include a shutter button configured to receive an input of at least one from among a photographing command and an auto focusing command, and the controlling may include, in response to the at least one from among the photographing command and the auto focusing command being received via the shutter button, controlling the haptic component to provide the first vibration feedback based on the received at least one from among the photographing command and the auto focusing command.

The inputter may include a touch screen configured to receive a user touch input and to display a photographed image, and the controlling may include, in response to the user command being received via the touch screen, controlling the haptic component to provide the first vibration feedback based on the user command.

The inputter may further include a touch haptic component configured to provide a second vibration feedback on the touch screen, and the controlling may include, in response to the user command being received via the touch screen, controlling the touch haptic component to provide the second vibration feedback to a first point on the touch screen at which the user command is inputted.

The controlling may include, in response to a user touch input which is received at a second point on the touch screen, controlling the touch screen to display a jog dial UI at the second point, and controlling the touch haptic component to provide a third vibration feedback to the second point.

The touch screen may further include a touch pressure sensor configured to detect a touch pressure of the user, and the controlling may include controlling the touch haptic component to provide a third vibration feedback according to the detected touch pressure, such that the third vibration feedback is different from the first vibration feedback and the second vibration feedback.

In addition, the haptic component may include a plurality of actuators disposed on the area at which the user grips the image photographing device, and the controlling may include driving each of the plurality of actuators at a different respective time in order to provide a different respective vibration feedback based on the user command.

The haptic component may include an actuator which includes a plunger and which is disposed on the area at which the user grips the image photographing device, and the actuator may be configured to linearly reciprocate in a vertical direction or a horizontal direction.

In addition, the haptic component may include an actuator which has a form of a thin film and which is disposed on the area at which the user grips the image photographing device.

According to another aspect of one or more exemplary embodiments, an image photographing device includes: an image obtainer configured to photograph an image; an inputter configured to receive an input of a user command; a haptic component disposed on an area of a body of the image photographing device at which a user grips the image photographing device and configured to provide a vibration feedback to the user, and to measure grip pressure of the user; and a controller configured to execute a function that corresponds to a pressure value measured by the haptic component.

The haptic component may be implemented by using a piezoelectric actuator.

According to various exemplary embodiments as described above, a user can feel a vibration feedback that corresponds to a user command, so that emotional satisfaction can be enhanced when the user uses the image photographing device. In addition, the image photographing device senses on the grip area, so that the user can use the image photographing device more easily and intuitively.

According to various exemplary embodiments as described above, the image photographing device can provide a vibration feedback that corresponds to a user command, and receive an input of a user command via the touch screen efficiently.

Additional and/or other aspects and advantages of the exemplary embodiments will be set forth in part in the description which follows and, in part, will be apparent from the description, or may be learned by practice of the exemplary embodiments.

### BRIEF DESCRIPTION OF THE DRAWINGS

The above and/or other aspects will be more apparent by describing certain exemplary embodiments with reference to the accompanying drawings, in which:

FIG. 1 is a block diagram schematically illustrating a configuration of an image photographing device, according to an exemplary embodiment;

FIG. 2 is a block diagram illustrating a configuration of an image photographing device in detail, according to an exemplary embodiment;

FIGS. 3A, 3B, and 3C are views to illustrate changing a configuration of a haptic unit by using an actuator, according to an exemplary embodiment;

FIGS. 4A, 4B, and 4C are views to illustrate a configuration of a touch screen and an exterior of an image photographing device that includes the touch screen, according to an exemplary embodiment;

FIGS. 5A and 5B are views to illustrate providing a vibration feedback to a user, according to an exemplary embodiment;

FIG. 6 is a view to illustrate generating a jog dial UI on a touch screen, according to an exemplary embodiment;

FIGS. 7A and 7B are views to illustrate executing a UI which is generated on a touch screen, according to an exemplary embodiment;

FIGS. 8A and 8B are views to illustrate displaying a photographed image and a UI on a touch screen, according to an exemplary embodiment;

FIGS. 9 and 10 are flowcharts to illustrate a method for controlling an image photographing device, according to an exemplary embodiment; and

FIG. 11 is a view to illustrate grip data which is generated when a user grips a grip area of an image photographing device, according to an exemplary embodiment.

### DETAILED DESCRIPTION

The exemplary embodiments may be diversely modified. Accordingly, specific exemplary embodiments are illustrated in the drawings and are described in detail in the detailed description. However, it is to be understood that the present inventive concept is not limited to a specific exemplary embodiment, but includes all modifications, equivalents, and substitutions without departing from the scope and spirit of the present inventive concept. Also, well-known functions or constructions are not described in detail since they would obscure the exemplary embodiments with unnecessary detail.

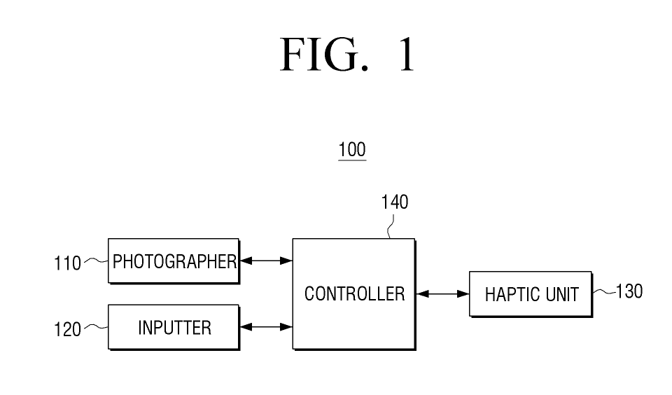

Hereinafter, exemplary embodiments will be explained in detail with reference to the accompanying drawings. FIG. 1 is a block diagram schematically illustrating a configuration of an image photographing device 100, according to an exemplary embodiment. As shown in FIG. 1, the image photographing device 100 includes a photographer (also referred to herein as an “image obtainer”) 110, an inputter 120, a haptic unit (also referred to herein as a “haptic component”) 130, and a controller 140.

The photographer 110 includes an Auto Focusing (AF) module, an aperture, an image sensor, etc., which are not shown. In this case, the photographer 110 may photograph an image in response to a photographing command being received via the inputter 120.

The inputter 120 receives an input of a user command. In this case, the inputter 120 may be implemented by using any of a shutter, a button, a touch screen, etc. provided on the exterior of the image photographing device 100. According to an exemplary embodiment, the inputter 120 may be implemented by using a shutter button that is configured to receive an input of a photographing command and a touch screen that is configured to display an image photographed by the photographer. In this case, the touch screen may be implemented by using a button excluding the shutter button, a jog dial, etc. generated thereon.

The haptic unit 130 may generate a sense of vibration that corresponds to a user command under the control of the controller 140. According to an exemplary embodiment, the haptic unit 130 may be provided with a plurality of actuators on an area at which the user grips the image photographing device 100, and the controller 140 may drive each of the plurality of actuators at different respective times in order to provide a different respective vibration feedback according to a user command. In addition, the haptic unit 130 may be provided with an actuator which is disposed on the area at which the user grips the image photographing device 100 and which includes a plunger, and may be configured to linearly reciprocate in either or both of the vertical and horizontal directions. According to an exemplary embodiment, the haptic unit 130 may be provided with a piezoelectric actuator configured on the area where the user grips the image photographing device 100 in the form of a film, such as, for example, a thin film.

The controller 140 may control the overall operation of the image photographing device 100. Specifically, in response to a user command being received via the inputter 120, the controller 140 may control the haptic unit 130 to provide a vibration feedback that corresponds to the received user command.

In particular, in response to a photographing command or an auto focusing command being received via the shutter button, the controller 140 may control the haptic unit 130 to provide a vibration feedback that corresponds to the received photographing command or the received auto focusing command.

According to an exemplary embodiment, in response to a user command being received via the touch screen, the controller 140 may control the haptic unit 130 to provide a vibration feedback that corresponds to the received user command. In particular, the inputter 120 may further include a touch feedback component configured to provide the vibration feedback on the touch screen, and, in response to a user command being received via the touch screen, the controller 140 may control the haptic unit 130 to provide the vibration feedback at a point on the touch screen at which the user command is inputted.

In addition, in response to a user touch input which is received at a particular point on the touch screen and then, for example, draws a circle while dragging is being inputted, the controller 140 may control the touch screen to display a jog dial user interface (UI) at the point on the touch screen at which the user touch is inputted, and control the touch feedback component to provide the vibration feedback to the point where the user touch is inputted.

In addition, when the touch screen includes a touch pressure sensor configured to detect a user's touch pressure, the controller 140 may control the haptic unit 130 to provide a different vibration feedback according to a user's touch pressure as detected by the touch pressure sensor.

In addition, when the haptic unit 130 is implemented by a piezoelectric actuator according to an exemplary embodiment, the controller 140 may control the haptic unit 130 to enable the piezoelectric actuator to measure the grip pressure of the user, and to provide a function that corresponds to a measured pressure value.

In addition, according to another exemplary embodiment, the image photographing device may be provided with a pressure measurement sensor configured to measure the grip pressure of the user on a grip area of the image photographing device, and may provide a function that corresponds to a pressure value measured by the pressure measurement sensor.

As described above, the image photographing device which includes the touch screen may provide the vibration feedback in correspondence to the user command.

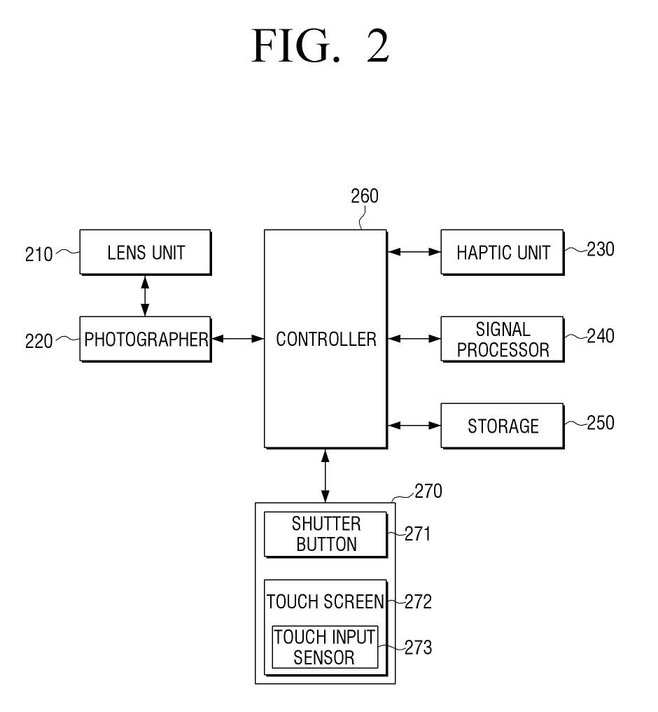

Hereinafter, the image photographing device will be explained in detail with reference to FIGS. 2 to 8B.

FIG. 2 is a block diagram illustrating a configuration of an image photographing device 100 in detail, according to an exemplary embodiment. As shown in FIG. 2, the image photographing device 100 includes a lens unit (also referred to herein as a “lens component”) 210, a photographer (also referred to herein as an “image obtainer”) 220, a haptic unit (also referred to herein as a “haptic component”) 230, a signal processor 240, a storage 250, a controller 260, and an inputter 270. In this case, the inputter 270 may include a shutter button 271 and a touch screen 272 provided with a touch pressure sensor 273.

The lens unit 210 collects light from a subject and photographs an image. Specifically, in response to a photographing command being inputted by the user, the lens unit 210, which is disposed on the front surface of the image photographing device 100, photographs an image.

In this case, the lens unit 210 may be implemented as a separate hardware configuration which is distinguished from the photographer 220. However, the lens unit 210 may be included in the photographer 220.

The photographer 220 may include an AF module, an aperture, a Charge Coupled Device (CCD) image sensor, an Analog/Digital Converter (ADC) and/or elements, which are not shown in the drawing. In this case, the photographer 110 may be configured to photograph an image in response to a photographing command being received from the inputter 270.

The AF module may be configured to automatically adjust the focal point of the image desired by the user. According to an exemplary embodiment, in response to an auto focusing command being received, the controller 260 may control the haptic unit 230 to provide a vibration feedback that corresponds to the auto focusing command. This will be explained in detail below.

The aperture adjusts the amount of incident light according to the degree of opening/closing. The CCD image sensor may accumulate the amount of light that enters through the lens unit and then output the image photographed by the lens unit 210 according to the accumulated amount of light. In the image photographing device 100, the image is obtained by the CCD image sensor which converts the light reflected from a subject into an electric signal. A color filter is required to obtain a color image by using the CCD image sensor, and a filter known as a Color Filter Array (CFA) is mostly employed. The CFA allows only the light indicating one color for one pixel to pass therethrough and has regular arrangements, and may have various patterns based on the arrangements. The ADC converts an analog image signal outputted from the CCD image sensor into a digital signal.

The above-described method for the photographer 220 to photograph the image is merely an example, and the image may be photographed by employing other methods. For example, the image may be photographed by using a Complementary Metal Oxide Semiconductor (CMOS) image sensor rather than the CCD image sensor.

In response to an occurrence of a predetermined event, the haptic unit 230 provides a haptic feedback that corresponds to the predetermined event. In this case, the haptic feedback of the image photographing device according to an exemplary embodiment is technology which generates a vibration, force, or shock in the image photographing device 100 and thus enables the user to feel the vibration, force, or shock, and may be referred to as computer haptic technology. In particular, in response to a user command being received, the haptic unit 230 may provide a sense of vibration that corresponds to the user command under the control of the controller 260.

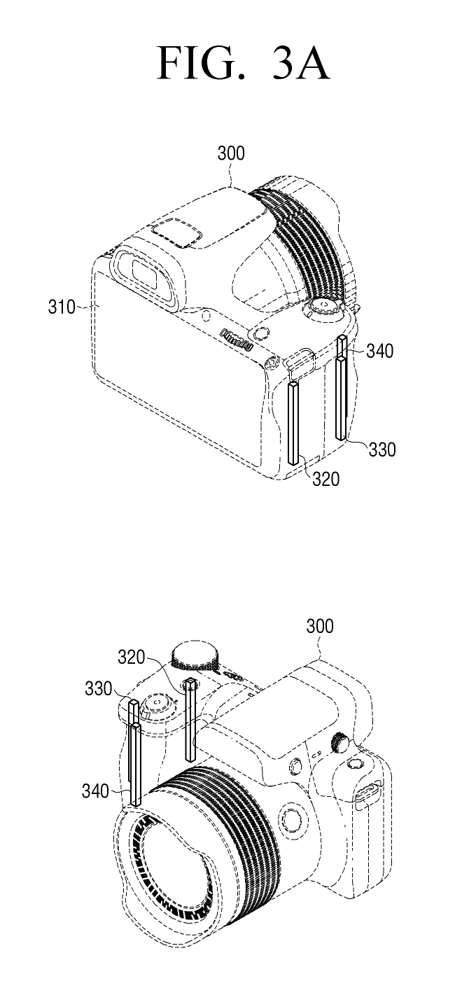

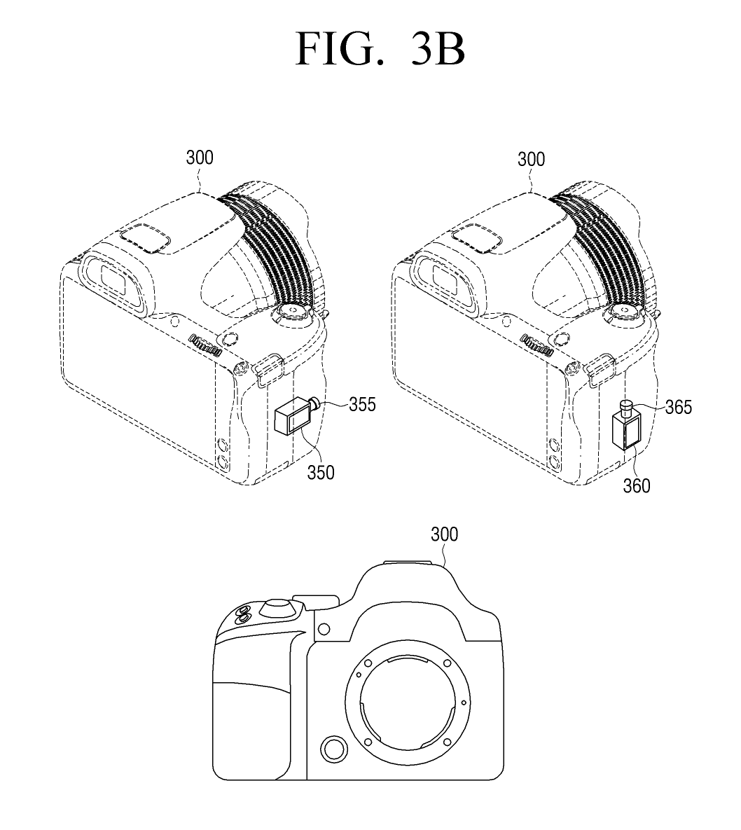

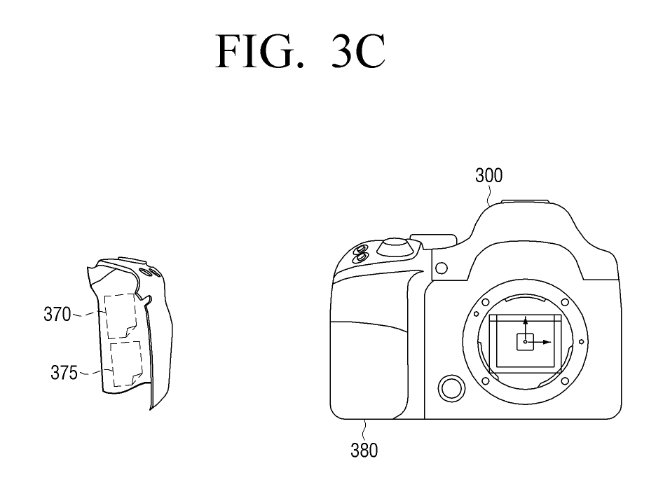

According to an exemplary embodiment, the haptic unit 230 may be provided with a plurality of actuators on an area where the user grips the image photographing device 100, and the controller 260 may drive each of the plurality of actuators at different respective times in order to provide a different respective vibration feedback based on a user command. For example, when the haptic unit 230 is provided with a plurality of lead zirconate titanate (PZT) ultrasonic actuators as shown in FIG. 3A, the controller 260 drives each of the plurality of actuators 320, 330, and 340 at different respective times using rapid response characteristics of the actuators, thereby generating a vibration, force, or shock.

In addition, the haptic unit 230 may be provided with an actuator that includes a plunger and is disposed on the area where the user grips the image photographing device 100, and the actuator may be configured to linearly reciprocate in the vertical or horizontal direction. For example, as shown in FIG. 3B, the haptic unit 230 may have a structure in which the direct hit type actuators 350, 355, 360, 365 is configured to directly hit the cover of a grip. In this case, when the haptic unit 230 is implemented by the actuator 350, 355 which includes a plunger, as shown in the left view of FIG. 3B, the controller 260 may control the actuator to linearly reciprocate in the horizontal direction, thereby generating a vibration, force, and/or shock. In addition, when the haptic unit 230 is implemented by the actuator 360, 365 which includes a plunger as shown in the right view of FIG. 3B, the controller 260 may control the actuator 360, 365 to linearly reciprocate in the vertical direction, thereby generating a vibration, force, and/or shock.

The bottom view of FIG. 3B is a view showing an exterior of an image photographing device 300 that includes an actuator which includes a plunger and which is disposed on an area where the user grips the image photographing device 300.

In addition, the haptic unit 230 may include an actuator which is disposed on the area where the user grips the image photographing device 300 and which has the form of a thin film. For example, as shown in FIG. 3C, the actuators 370, 375 which are implemented in the form of a thin film may be manufactured along with a part of a cover 380 of a grip part of the image photographing device, or may be attached to the cover 380. In this case, the piezoelectric actuators 370, 375 in the form of a thin film may be attached to the surface of the cover, thereby providing a sense of vibration to the user.

According to an exemplary embodiment, when the haptic unit 230 is implemented by the piezoelectric actuator, the controller 260 may be configured to control the piezoelectric actuator to measure the grip pressure of the user (for example, gripping force, grasping force). In this case, the controller 260 may generate various input signals for executing a function that corresponds to the measured level of the grip pressure.

According to another exemplary embodiment, when the image photographing device is provided with a pressure measurement sensor which is disposed on the grip area of the image photographing device and which is configured to measure the grip pressure of the user, the controller 260 may generate various input signals to execute a function that corresponds to a grip pressure level measured by the pressure measurement sensor.

When the separate pressure measurement sensor is attached to the grip area of the image photographing device as described above, the grip may be easily sensed. The signal processor 240 processes signals that relate to the image received from the photographer, and transmits the processed image signals to the touch screen 272 in order to display the photographed image. In addition, the signal processor 240 may output the processed image signals to a coder/decoder (i.e., “codec”) (not shown) in order to store the photographed image. In particular, the signal processor 240 may perform format conversion, digital zoom for adjusting an image scale, and/or Auto White Balance (AWB) with respect to the image signals outputted from the photographer 220.

The above-described method for the signal processor 240 to process the image is merely an example, and the image may be processed by employing other methods.

The inputter 270 may receive an input of user's manipulation. In this case, the inputter 270 may be implemented by using the shutter button 271, a button, and the touch screen 272 provided on the exterior of the image photographing device 100, 300.

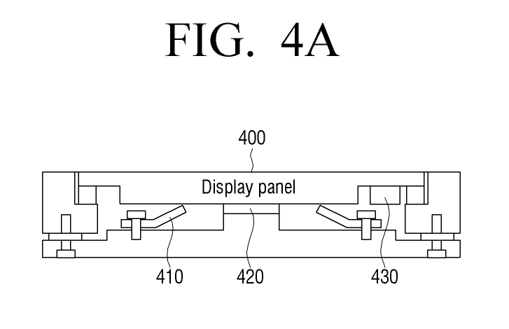

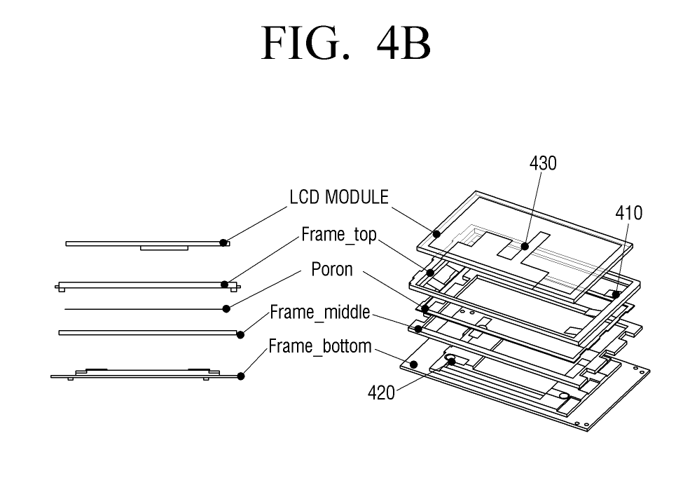

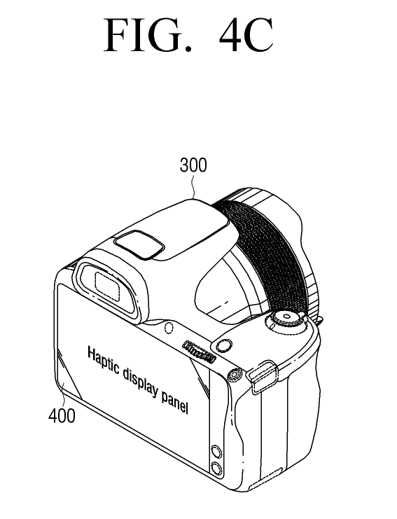

According to an exemplary embodiment, when the inputter 270 is implemented by using the touch screen 272, the inputter 270 may include a touch haptic unit (also referred to herein as a “touch haptic component”), which is configured to provide a vibration feedback on the touch screen 272, and a touch pressure sensor 273, which is configured to detect the touch pressure of the user. In this case, the controller 260 may control the touch haptic unit to provide a different vibration feedback based on the touch pressure of the user as detected by the touch pressure sensor 273. In particular, the touch haptic unit may be configured in the same way as the haptic unit 230 as described above. In addition, the touch screen 272 may be supported by an elastic material. More particularly, as shown in FIGS. 4A and 4B, the touch screen 272 may include a display panel 400, an actuator 430 configured to implement haptic, a leaf spring 410 configured to guarantee a floating structure, a touch pressure sensor 420, 273 configured to detect the touch pressure of the user, a liquid crystal display (LCD) module, a top frame, poron, a middle frame, and a bottom frame. In this case, in response to the user inputting a touch to the display panel 400, the controller 260 may control the touch pressure sensor 420, 273 to measure the touch pressure of the user and control the touch haptic unit (or the haptic unit) to provide a sense of vibration that corresponds to the measured touch pressure. In particular, when the touch haptic unit 230 is provided with the plurality of PZT ultrasonic actuators as shown in FIG. 3A, the controller 260 may drive the plurality of actuators 320. 330, 340 at different times using the rapid response characteristics of the actuators, thereby generating a vibration, force, and/or shock. In this case, the controller 260 may control the touch haptic unit 230 to provide a different vibration feedback based on the touch pressure of the user as detected by the touch pressure sensor 273, 420.

FIG. 4C is a view showing the exterior of the image photographing device 100, 300 when the inputter 270 of the image photographing device 100, 300 is implemented by using the touch screen 272.

The touch screen 272 configured as described above is merely an example, and may be configured by employing other methods in order to implement a touch haptic function.

The storage 250 stores programs and data for driving the image photographing device 100, 300, and stores image data which is processed in the signal processor 240.

The controller 260 may control the overall operation of the image photographing device 100, 300 according to a user command which is inputted via the inputter 270. In particular, in response to a user command being received via the inputter 270, the controller 260 may control the haptic unit 230 to provide a vibration feedback that corresponds to the received user command. In addition, the controller 260 may control a UI generator (not shown) to generate a UI. In this case, the UI generator (not shown) may generate any of a button UI, a jog dial UI and a various function execution UI to be provided to the exterior of the image photographing device 100, 300.

The UI generator (not shown) may be included in the controller 260, or may be implemented as a separate hardware configuration.

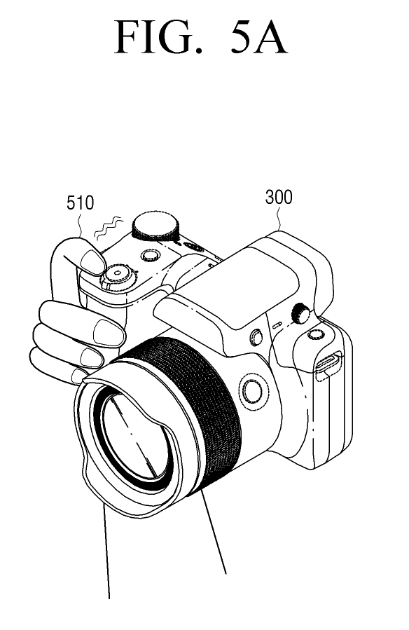

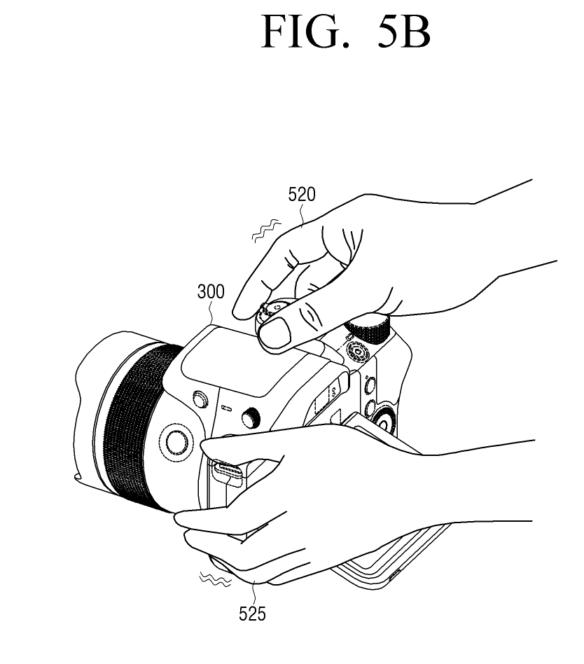

In particular, when the inputter 270 includes the shutter button 271 which is configured to receive an input of a photographing command and/or an input of an auto focusing command, and a photographing command or an auto focusing command is inputted via the shutter button 271, the controller 260 may control the haptic unit 230 to provide a vibration feedback that corresponds to the photographing command or the auto focusing command. For example, when the user photographs in such a posture that the user has difficulty in identifying a photographed image through the display provided on the rear surface of the image photographing device 100, 300 as shown in FIGS. 5A and 5B, and the auto focusing or photographing is completed (i.e., exposure is completed) after the user inputs the photographing command, the controller 260 may control the haptic unit 230 to provide a vibration feedback 510, 520 that corresponds to the completion of the auto focusing or photographing (i.e., exposure).

According to an exemplary embodiment, when the image photographing device 100, 300 continuously photographs a still image, the controller 270 may control the haptic unit 230 to provide a vibration feedback of a different vibration strength after the initial image photographing operation, in order to be distinguished from a vibration feedback of an initial vibration strength that is provided based on the initial image photographing operation. For example, when the image photographing device 100, 300 is provided with the plurality of actuators 320, 330, 340 on the grip area thereof as shown in FIG. 3A, the controller 260 drives the plurality of actuators 320, 330, 340 at different times in order to provide a respective vibration feedback of different vibration strength. For example, when the user photographs for the first time, the controller 260 may drive one of the plurality of actuators 320, 330, 340 and transmit a first sense of vibration. After that, when the user photographs for the second time, the controller 260 may drive two of the plurality of actuators 320, 330, 340 and transmit a second sense of vibration.

The method for controlling the haptic unit 230 to provide a vibration feedback of different vibration strength is not limited to the above-described exemplary embodiment (FIG. 3A), and may be applied to the exemplary embodiments of FIGS. 3B and 3C, and the haptic function may be implemented by employing any of various methods.

According to an exemplary embodiment, when the image photographing device 100, 300 converts from a sleep mode into a photographing mode, the controller 260 may control the haptic unit 230. For example, when the user starts photographing in such a posture that the user has difficulty in determining whether the image photographing device 100, 300 is in the sleep mode or the photographing mode, as shown in FIGS. 3A, 3B, and 3C, the controller 260 controls the haptic unit 320, 330 340, 350, 355, 360, 365, 370 and 375 to provide a sense of vibration informing that the sleep mode is converted into the photographing mode to the user.

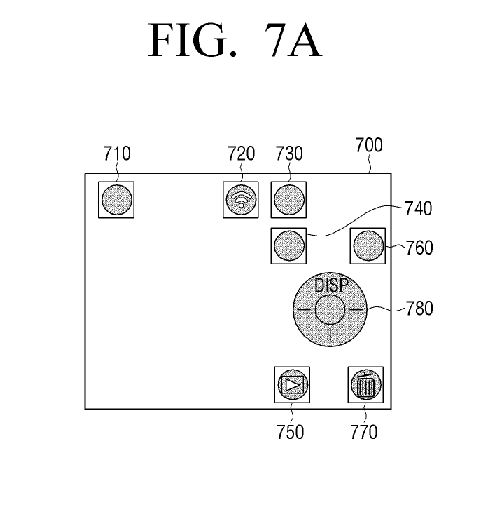

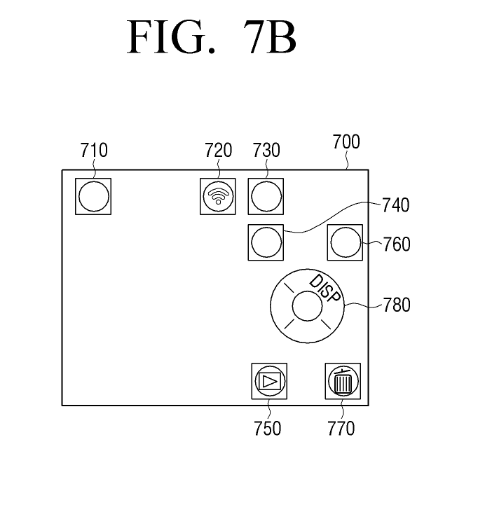

According to another exemplary embodiment, the inputter 270 may be implemented by using the touch screen 272 which displays a photographed image and receives an input of a user's touch. In this case, in response to a user command being received via the touch screen 272, the controller 260 may control the haptic unit 230 to provide a vibration feedback that corresponds to the user command. In this case, when a touch haptic unit is provided to provide a vibration feedback on the touch screen 272, and a user command is inputted on the touch screen, the controller 260 may control the touch haptic unit to provide the vibration feedback to the point where the user command is inputted. For example, when the inputter 270 is implemented by using a touch screen 700 as shown in FIG. 7A, the controller 260 may display various button UIs 710, 720, 730, 740, 750, 760, 770 and a jog dial UI 780 which are configured to execute functions of the image photographing device 100, 300. In this case, in response to the user touching the button UIs 710, 720, 730, 740, 750, 760, 770 other than the jog dial UI 780, the controller 260 may control the haptic unit 230 to provide a vibration feedback that corresponds to the user command. In particular, in response to the user touching the WiFi function execution UI 720, the controller 260 may control the touch haptic unit to provide a vibration feedback to the point at which the WiFi function execution UI 720 is located.

In addition, the controller 260 may control the touch screen 270, 700 to display the button UIs 710, 720, 730, 740, 750, 760, 770 other than the jog dial LI 780 in different colors and thus to distinguish between a currently executed UI and the other button UIs (which are not touched by the user).

According to an exemplary embodiment, when the touch screen 700 includes a touch pressure sensor 273, 420 which is configured to detect the touch pressure of the user, the controller 260 may control the haptic unit (or the touch haptic unit) to provide a different vibration feedback based on the touch pressure of the user as detected by the touch pressure sensor 273, 420. For example, in response to the user touching the WiFi function execution UI 780 and then touching the deletion function execution UI 770 in sequence as shown in FIGS. 7A and 7B, the controller 260 may control the touch pressure sensor 273, 420 to measure the touch pressure of the user. In this case, when the touch pressure of the WiFi function execution UI 780 is determined to be stronger than that of the deletion function execution UI 770 as a result of comparing the touch pressure of the WiFi function execution UI 780 with the touch pressure of the deletion function execution UI 770, the controller 260 may control the haptic unit (or the touch haptic unit) to provide the WiFi function execution UI 780 with a vibration feedback of a strength which is stronger than that of a vibration feedback provided to the deletion function execution UI 770.

According to another exemplary embodiment, in response to the amount of pressure of the user touch input detected by the touch pressure sensor 273, 420 being greater than or equal to a predetermined value, the controller 260 may control the haptic unit (or the touch haptic unit) to provide a vibration feedback that corresponds to the user touch command. In this case, in response to the amount of pressure of the user touch input detected by the touch pressure sensor 273, 420 being greater than or equal to the predetermined value, the controller 260 may control the haptic unit (or the touch haptic unit) to provide a different vibration feedback based on the touch pressure of the user as detected by the touch pressure sensor 273, 420. In addition, in response to the amount of pressure of the user touch input detected by the touch pressure sensor 273, 420 being less than the predetermined value, the controller 260 may control not to provide a vibration feedback and not to execute a corresponding function. In this manner, the controller 260 may control to receive an input only when an amount of physical force that is greater than or equal to the predetermined value is applied for the user touch input.

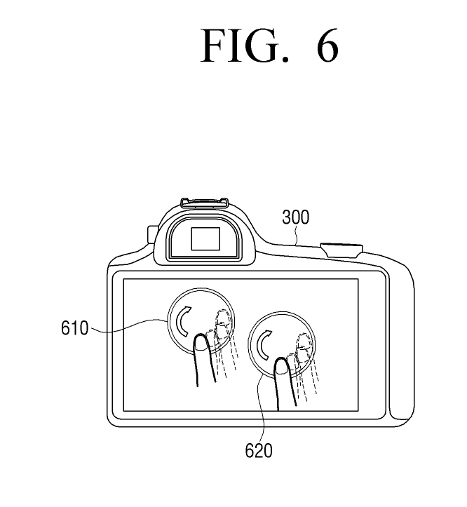

According to an exemplary embodiment, in response to a user touch which is received at a certain point on the touch screen 272 and then drags while drawing a circle being inputted, the controller 260 may control the touch screen 272 to display the jog dial UI at the point where the user touch is received, and control the touch haptic unit (or the haptic unit) to provide a vibration feedback to the point where the user touch is received. For example, in response to a touch 610, 620 which drags in the clockwise direction being inputted to the touch screen 272 in the clockwise direction as shown in FIG. 6, the controller 260 may generate the jog dial UI at the points 610, 620 where the user touch is inputted. Thereafter, the controller 260 may control the touch haptic unit (haptic unit) to provide a vibration feedback to the points where the touch is inputted (i.e., the points 610, 620 where the jog dial UI is generated).

In addition to the above-described jog dial UI, other button UIs may be generated at the point(s) where the user touch is inputted. After the jog dial UI and the other button UIs are generated, they may be moved to other locations based on a user touch input.

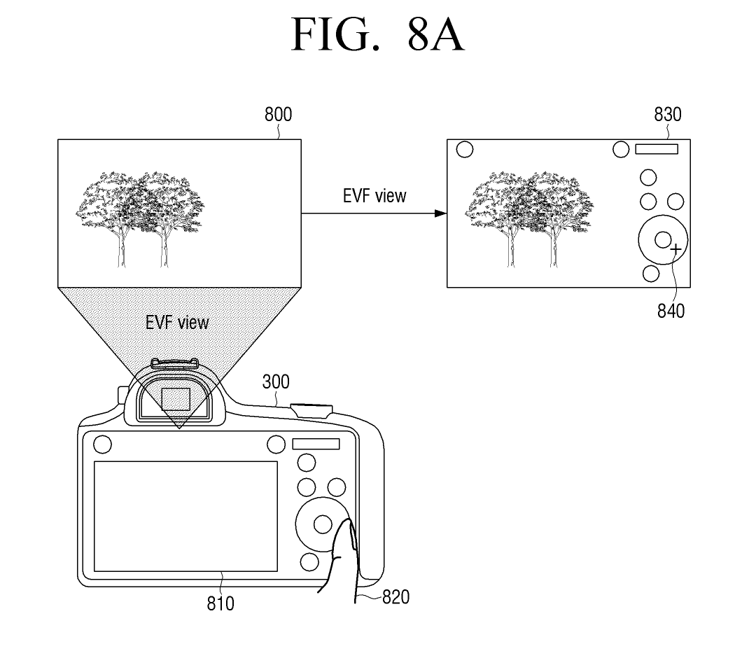

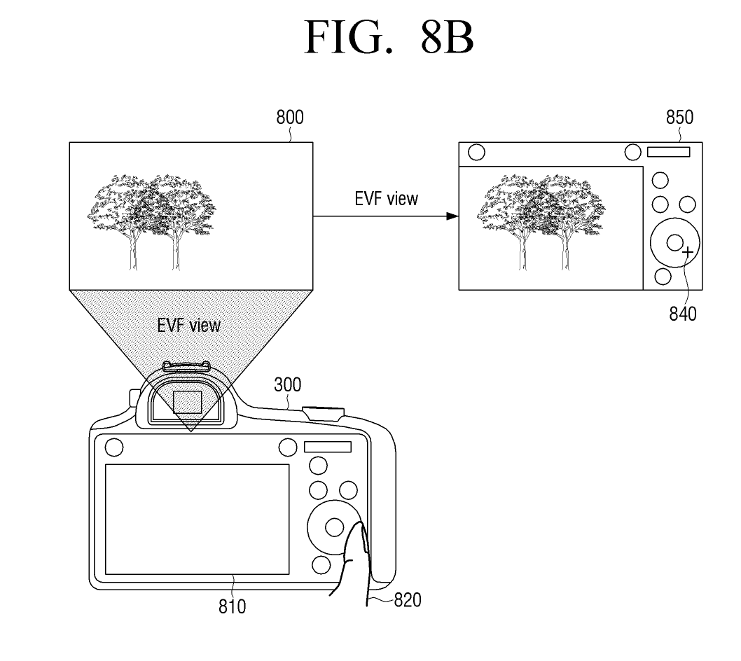

According to an exemplary embodiment, the controller 260 may control the image photographing device 100 to photograph an image and display the photographed image or the image which is being photographed on the touch screen 272, and may control the touch screen 272 to display various function execution UIs, including the jog dial UI, so as to overlap the displayed image. For example, as shown in FIG. 8A, a conventional image photographing device 810 which is not implemented by using a touch screen includes a display 810 configured to display a photographed image and various physical buttons 820 which are separately implemented from the display 810. When the display is implemented by using a touch screen 830 according to an exemplary embodiment, the controller 260 may control the touch screen 830 to display various function execution UIs 840, including a jog dial UI, so as to overlap a photographed image (or an image which is being photographed).

In addition, referring to FIG. 8B, when the display is implemented by using the touch screen 850, the controller 260 may control the touch screen 850 to display the various function execution UIs 840, including the jog dial UI, on the periphery of the photographed image (or the image which is being photographed), as shown in FIG. 8B.

In addition, the displaying the photographed image (or the image which is being photographed) and the various function execution UIs 840 including the jog dial UI so as to overlap each other or be separated from each other may be variously changed according to user settings. For example, the controller 260 may control the touch screen 830, 850 to display the photographed image (or the image which is being photographed) on the right and to display the various function execution UIs 840 including the jog dial UI so as to overlap or to be separated on the left or to be displayed on various locations.

According to an exemplary embodiment, the controller 260 may control the touch screen 270 to display an indicator 840 on a location 820 to which a user touch is inputted on the touch screen 270. In this case, as shown in FIGS. 8A and 8B, the indicator 840 may be illustrated by using the symbol “+”, but may alternatively be displayed in any of various forms.

In addition, in response to the user's touch input on the touch screen 270 approaching the various function execution UIs including the jog dial UI to within a predetermined proximity, the controller 260 may control the haptic unit (or the touch haptic unit) to provide a vibration feedback.

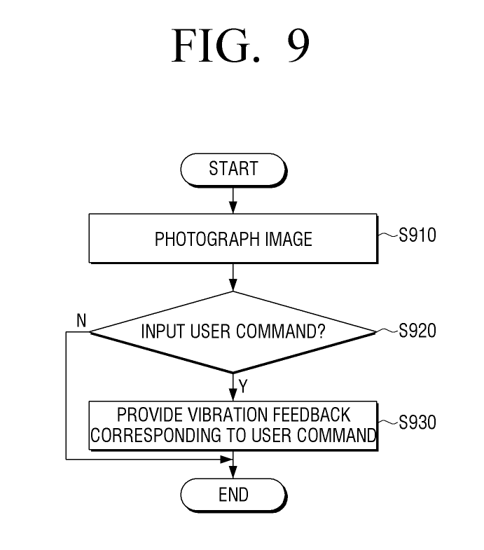

Hereinafter, a control method of an image photographing device according to an exemplary embodiment will be explained with reference to FIG. 9.

First, in operation S910, in response to a photographing command being received, the image photographing device 100 may perform an image photographing function.

Thereafter, in response to a user command being received via the inputter 120 in operation S920, the image photographing device 100 may provide a vibration feedback that corresponds to the received user command in operation S930. In particular, when the image photographing device 100 includes a shutter button 271 configured to receive an input of a photographing command or an input of an auto focusing command, and a photographing command or an auto focusing command is received via the shutter button 271, the image photographing device 100 may control the haptic unit 230 to provide a vibration feedback that corresponds to the photographing command or auto focusing command. For example, when the user photographs in such a posture that the user has difficulty in identifying a photographed image through the display provided on the rear surface of the image photographing device 100, 300 as shown in FIGS. 5A and 5B, and the auto focusing or photographing is completed (i.e., exposure is completed) after the user inputs the photographing command, the controller 260 may control the haptic unit 230 to provide a vibration feedback 510, 520 that corresponds to the completion of the auto focusing or photographing (i.e., exposure).

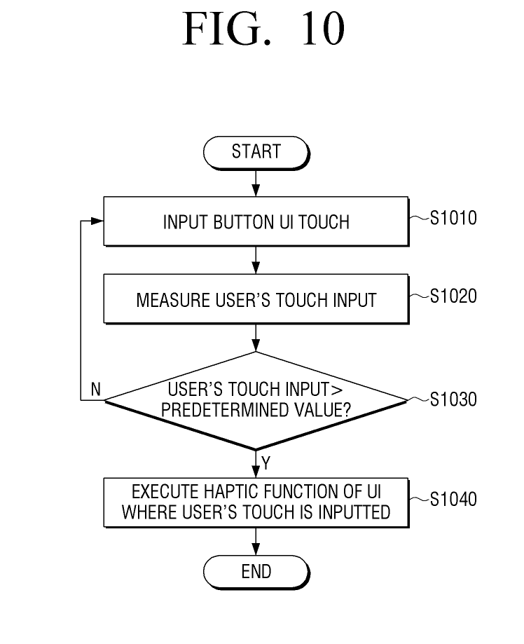

Hereinafter, a control method of an image photographing device according to an exemplary embodiment will be explained in detail with reference to FIG. 10.

First, in response to the user touching one of the various function execution button UIs displayed on the touch screen 270 in operation S1010, the image photographing device 100 may control the touch pressure sensor 273, 420 to measure the touch pressure of the user in operation S1020.

Thereafter, in response to the user's touch pressure being determined as greater than or equal to a predetermined value in operation S1030, the image photographing device 100 may control the haptic unit (or the touch haptic unit) to execute a haptic function of the UI to which the user touch is inputted, in operation S1040.

In response to the user's touch pressure being determined as less than the predetermined value in operation S1030, the image photographing device 100 may receive an input of a user touch again in operation S1010.

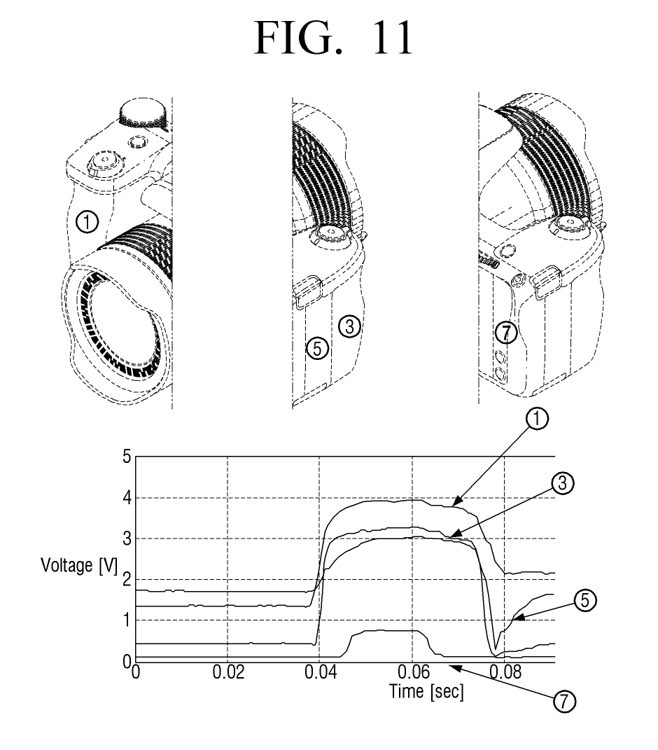

Hereinafter, grip data which is generated when the user grips the grip area of the image photographing device according to an exemplary embodiment will be explained with reference to FIG. 11.

The user applies pressure to the grip area of the image photographing device in order to photograph with the image photographing device. In this case, when the haptic unit 230 is configured by a piezoelectric actuator according to an exemplary embodiment, the controller 260 may control the piezoelectric actuator to measure the grip pressure of the user. When the image photographing device is provided with a pressure measurement sensor on the grip area according to another exemplary embodiment, the controller 260 may measure the grip pressure of the user by using the pressure measurement sensor. Thereafter, the controller 260 may execute a function that corresponds to the measured grip pressure. For example, when the image photographing device enters a sleep mode after a predetermined time in the power-on state, and then the user applies pressure to the grip area of the image photographing device, the controller 260 may measure the pressure on the grip area gripped by the user by using the piezoelectric actuator or the pressure measurement sensor as shown in FIG. 11. In particular, when the user grips one of the areas \textcircled{1}, \textcircled{3}, \textcircled{5}, \textcircled{7} of the image photographing device, the controller 260 may measure the pressure on the grip area (one of the areas \textcircled{1}, \textcircled{3}, \textcircled{5}, \textcircled{7}) during a time of 0.05 seconds as shown in the first graph of FIG. 11, and execute a function that corresponds to the measured pressure (for example, converting from a sleep mode into a photographing preparing mode).

In the above-described exemplary embodiment, the function corresponding to the measured user grip pressure converts from the sleep mode into the photographing preparing mode. However, this should not be considered as limiting, and the function corresponding to the measured user grip pressure may be changed according to user settings.

A program code for performing the control method of the image photographing device according to various exemplary embodiments as described above may be stored in a non-transitory computer readable medium. The non-transitory readable medium refers to a medium that stores data semi-permanently rather than storing data for a very short time, such as a register, a cache, a memory or etc., and is readable by an apparatus. In particular, the above-described various applications or programs may be stored in a non-transitory readable medium such as, for example, any of a compact disc (CD), a digital versatile disk (DVD), a hard disk, a Blu-ray disk, a universal serial bus (USB), a memory card, a read only memory (ROM) or etc.

The foregoing exemplary embodiments and advantages are merely exemplary and are not to be construed as limiting with respect to the present inventive concept. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. An image photographing device comprising:
an image obtainer configured to photograph an image;
an inputter configured to receive an input of a user command;
a haptic component disposed on an area of a body of the image photographing device at which a user grips the image photographing device and configured to provide a first vibration feedback to the user; and
a controller configured to control the haptic component to provide the first vibration feedback that corresponds to the user command in response to the user command being received via the inputter.

2. The image photographing device of claim 1, wherein the inputter comprises a shutter button configured to receive an input of at least one from among a photographing command and an auto focusing command, and
wherein, in response to the at least one from among the photographing command and the auto focusing command being received via the shutter button, the controller is further configured to control the haptic component to provide the first vibration feedback based on the received at least one from among the photographing command and the auto focusing command.

3. The image photographing device of claim 1, wherein the inputter comprises a touch screen configured to receive a user touch input and to display an image photographed by the image obtainer, and
wherein, in response to the user command being received via the touch screen, the controller is further configured to control the haptic component to provide the first vibration feedback based on the user command.

4. The image photographing device of claim 3, wherein the inputter further comprises a touch haptic component configured to provide a second vibration feedback on the touch screen, and
wherein, in response to the user command being received via the touch screen, the controller is further configured to control the touch haptic component to provide the second vibration feedback to a first point on the touch screen at which the user command is inputted.

5. The image photographing device of claim 4, wherein, in response to a user touch input which is received at a second point on the touch screen, the controller is further configured to control the touch screen to display a jog dial user interface (UI) at the second point, and to control the touch haptic component to provide a third vibration feedback to the second point.

6. The image photographing device of claim 4, wherein the touch screen further comprises a touch pressure sensor configured to detect a touch pressure of the user, and
wherein the controller is further configured to control the touch haptic component to provide a third vibration feedback according to the detected touch pressure, wherein the third vibration feedback is different from the first vibration feedback and the second vibration feedback.

7. The image photographing device of claim 1, wherein the haptic component comprises a plurality of actuators disposed on the area at which the user grips the image photographing device, and
wherein the controller is further configured to drive each of the plurality of actuators at a different respective time in order to provide a different respective vibration feedback based on the user command.

8. The image photographing device of claim 1, wherein the haptic component comprises an actuator which comprises a plunger,
wherein the actuator is configured to linearly reciprocate in one from among a vertical direction and a horizontal direction.

9. The image photographing device of claim 1, wherein the haptic component comprises an actuator which has a form of a thin film.

10. A control method of an image photographing device, the control method comprising:
photographing an image;
receiving an input of a user command via an inputter; and
controlling a haptic component to provide a first vibration feedback that corresponds to the user command in response to the user command being received.

11. The control method of claim 10, wherein the inputter comprises a shutter button configured to receive an input of at least one from among a photographing command and an auto focusing command, and
wherein the controlling comprises, in response to the at least one from among the photographing command and the auto focusing command being received via the shutter button, controlling the haptic component to provide the first vibration feedback based on the received at least one from among the photographing command and the auto focusing command.

12. The control method of claim 10, wherein the inputter comprises a touch screen configured to receive a user touch input and to display a photographed image, and
wherein the controlling comprises, in response to the user command being received via the touch screen, controlling the haptic component to provide the first vibration feedback based on the user command.

13. The control method of claim 12, wherein the inputter further comprises a touch haptic component configured to provide a second vibration feedback on the touch screen, and
wherein the controlling comprises, in response to the user command being received via the touch screen, controlling the touch haptic component to provide the second vibration feedback to a first point on the touch screen at which the user command is inputted.

14. The control method of claim 13, wherein the controlling comprises, in response to a user touch input which is received at a second point on the touch screen, controlling the touch screen to display a jog dial user interface (UI) at the second point, and controlling the touch haptic component to provide a third vibration feedback to the second point.

15. The control method of claim 13, wherein the touch screen further comprises a touch pressure sensor configured to detect a touch pressure of the user, and
wherein the controlling comprises controlling the touch haptic component to provide a third vibration feedback according to the detected touch pressure, wherein the third vibration feedback is different from the first vibration feedback and the second vibration feedback.

16. The control method of claim 10, wherein the haptic component comprises a plurality of actuators disposed on the area at which the user grips the image photographing device, and
wherein the controlling comprises driving each of the plurality of actuators at a different respective time in order to provide a different respective vibration feedback based on the user command.

17. The control method of claim 10, wherein the haptic component comprises an actuator which comprises a plunger and which is disposed on the area at which the user grips the image photographing device,
wherein the actuator is configured to linearly reciprocate in one from among a vertical direction and a horizontal direction.

18. The control method of claim 10, wherein the haptic component comprises an actuator which has a form of a thin film and which is disposed on the area at which the user grips the image photographing device.

19. An image photographing device comprising:
an image obtainer configured to photograph an image;
an inputter configured to receive an input of a user command;
a haptic component disposed on an area of a body of the image photographing device at which a user grips the image photographing device and configured to provide a vibration feedback to the user, and to measure a grip pressure of the user; and
a controller configured to execute a function that corresponds to a pressure value measured by the haptic component.

20. The image photographing device of claim 19, wherein the haptic component is implemented by using a piezoelectric actuator.
